(19) United States
(12) Patent Application Publication
(10) Pub. No.: US 2018/0290288 A1
(43) Pub. Date: Oct. 11, 2018

(54) PORTABLE WORKBENCH ASSEMBLY

(71) Applicant: KETER PLASTIC LTD., Herzelyia (IL)

(72) Inventor: Yaron BRUNNER, Kibbutz Gvat (IL)

(73) Assignee: KETER PLASTIC LTD., Herzelyia (IL)

(21) Appl. No.: 15/570,909

(22) PCT Filed: May 4, 2016
(86) PCT No.: PCT/IL2016/050465

§ 371 Date: Oct. 31, 2017

Related U.S. Application Data
(60) Provisional application No. 62/156,540, filed on May 4, 2015.

(51) Int. Cl. B25H 1/04; B25H 3/02; B25H 1/12

(52) U.S. Cl. CPC B25H 1/04; B62B 1/16; B25H 1/12; B25H 3/023

(57) ABSTRACT

Provided is a portable workbench assembly including a receptacle and a cover therefore. The cover constitutes a workbench and has a top surface and a bottom surface with at least the top surface constituting a work top of the workbench. The top surface of the cover includes at least one utility portion and further includes at least one support flap, the support flap has at least a first position in which it extends flushly with the top surface of the work top, and a second position in which it extends at an angle thereto.

### TECHNOLOGICAL FIELD

The disclosed subject matter is directed towards a portable and adjustable workbench assembly.

### BACKGROUND ART

References considered to be relevant as background to the presently disclosed subject matter are listed below:
US20020105129
EP2140985

Acknowledgement of the above references herein is not to be inferred as meaning that these are in any way relevant to the patentability of the presently disclosed subject matter.

### BACKGROUND

Various types of workbenches and workbench assemblies are known in the art. One example disclosed in US2002105129A is directed to a workpiece support assembly which includes an elongated workpiece support structure and a pair of support members pivotally connected to one another towards upper ends thereof. The support members are pivotally movable between an open position and a folded position. The workpiece support structure has a workpiece support surface constructed and arranged to support a portion of a workpiece. The workpiece support assembly further includes a tabletop assembly. The tabletop assembly is movable into a deployed position in which the tabletop is disposed substantially horizontally in overlying relation to the workpiece support structure, with the pair of support members in their open operative position. The deployed tabletop presents an upper tabletop surface to support a workpiece. The tabletop assembly is movable, with the pair of support members in their open operative position, into a storage position which exposes the elongated workpiece support surface.

Another example disclosed in EP2140985 is directed to a workbench with a collapsible frame and a plurality of top members. The collapsible frame can include a first set of legs and a second set of legs that can be coupled to one of the top members. The frame and top members can be positioned and supported by the first and second sets of legs to form a pair of free standing structures that can be employed as work benches and/or saw horses.

### GENERAL DESCRIPTION

The disclosed subject matter is directed towards a portable workbench assembly. In particular, it is directed to a cover for a tool carrying receptacle or organizer, the cover constituting a workbench.

In accordance with an aspect of the disclosed subject matter, there is provided a portable toolbox comprising a receptacle member and a cover associated therewith. The cover comprising a top surface and a bottom surface with at least the top surface constituting a work top of the portable workbench. The top surface of the cover comprising at least one elongate cavity extending inboard from the edge of the cover. The work top further comprising at least one support flap, the support flap having at least a first position in which it extends flushly with the top surface of the work top and a second position in which it extends at an angle thereto. In accordance with one example, the flap is extending perpendicular to the top surface.

In accordance with an example, there are provided two support flaps extending at opposite ends of the cover surface, wherein in the second position one edge of the support flap is articulated to the work top and the opposite edge is extended at a height thereabove.

In accordance with one example, the support flaps are configured with a utility portion for supporting an elongate member thereon.

The term utility portion, as used herein in the specification and claims, defines any sort of arrangement configured for supporting a workpiece or a work tool and the like. For example, a utility portion can be a flat surface (e.g. for supporting a board of material) or a notch configured for supporting an elongate workpiece (being, for example, a V-notch, a right-angled notch, a semicircular notch and the like). The term also refers to workpiece/worktool supporting arrangement such as rails, slots, notches, openings, hooks etc.

In accordance with another example, the support flaps are configured for supporting a toolbox of smaller dimensions such that its sidewalls are restrained by the support flaps.

In accordance with an example of the disclosed subject matter, at least one support flap is hingedly attached such that it is pivotably movable between at least the first and the second positions.

In accordance with an example of the disclosed subject matter, the worktop can be configured with receptacles/compartments/trays configured at the top face thereof.

Optionally such compartments can be drawer-like receptacles configured at side walls of the utility member.

In accordance with an example of the disclosed subject matter, the worktop can be configured with at least one carrying handle. According to one particular example the handle is retractable when not in use.

In accordance with an example of the disclosed subject matter, the worktop can be configured for detachably attaching thereto utility hooks. Such utility hooks can be used for example for mounting thereon various equipment/gear and for supporting beams which can facilitate for setting up an extended work surface, a scaffold, etc.

In accordance with an example of the disclosed subject matter, the worktop can be configured for supporting rectangular cross-sectioned beams.

In accordance with an example of the disclosed subject matter, the worktop can be configured with modular utility portions, either fixed or replaceable. For example, such utility portions can comprise T-slots, router plates, router fences, measurement indicia, coupling ports, etc.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A and FIG. 1B illustrate a portable workbench assembly in a perspective view supporting workpieces thereon and with the support flaps in their first and second operative positions, in accordance with the disclosed subject matter;

FIG. 1C illustrates the workbench assembly of FIG. 1A with a toolbox of smaller dimensions mounted thereon and restrained by the support members;

FIG. 2 is a perspective side view of the workbench assembly of FIG. 1A, with the support flaps in their second operative position;

FIG. 3 is an enlarged view of a portion marked A in FIG. 1B, with the support flap in its first operative position, folded into the top surface of the assembly cover;

FIG. 4 is an enlarged view of a portion marked A in FIG. 1B, in a slightly different angle of viewings with the support flap in its first operative position, and with the workpieces removed therefrom;

FIGS. 5A to FIG. 5B illustrate in a perspective view an enlarged portion marked B in FIG. 1A, with the support flap in its second operative position and portion marked C in FIG. 1B, with the support flap removed to expose its resting cavity, respectively;

FIG. 6A illustrates a workbench in accordance with the disclosed subject matter supported over a back door of a pickup truck, detached from the receptacle;

FIGS. 6B and 6C illustrate the workbench assembly in operation, supporting thereon a wire bobbin and a workpiece, respectively; and

FIG. 6D illustrates the workbench supported over collapsible support legs.

### DETAILED DESCRIPTION OF EMBODIMENTS

The disclosed subject matter is directed towards a portable workbench assembly. In particular it is directed to a utility cover for a tool carrying receptacle or organizer, the cover constituting a workbench.

Turning to the drawings now wherein like reference numerals refer to like parts throughout the various drawings, reference numeral 100 is generally designated as a portable workbench assembly in accordance with the disclosed subject matter.

In accordance with an example, the portable workbench and/or its cover are constructed of a high strength molded plastic material, although it will be appreciated that any material of suitable strength and weight, such as metal, polymeric material, etc. can be used in all or any portion thereof.

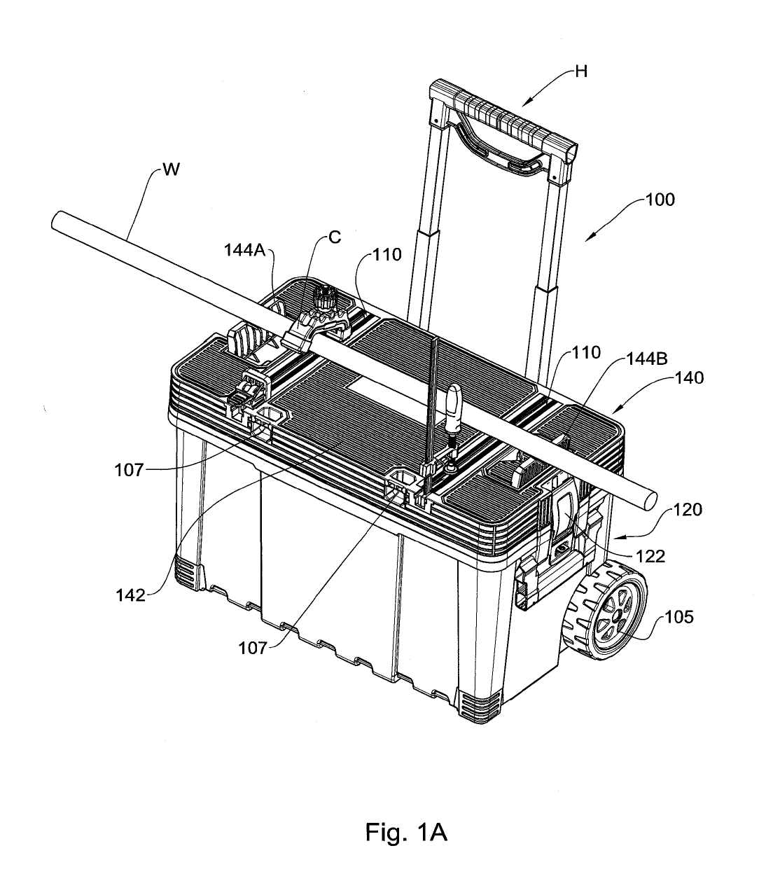

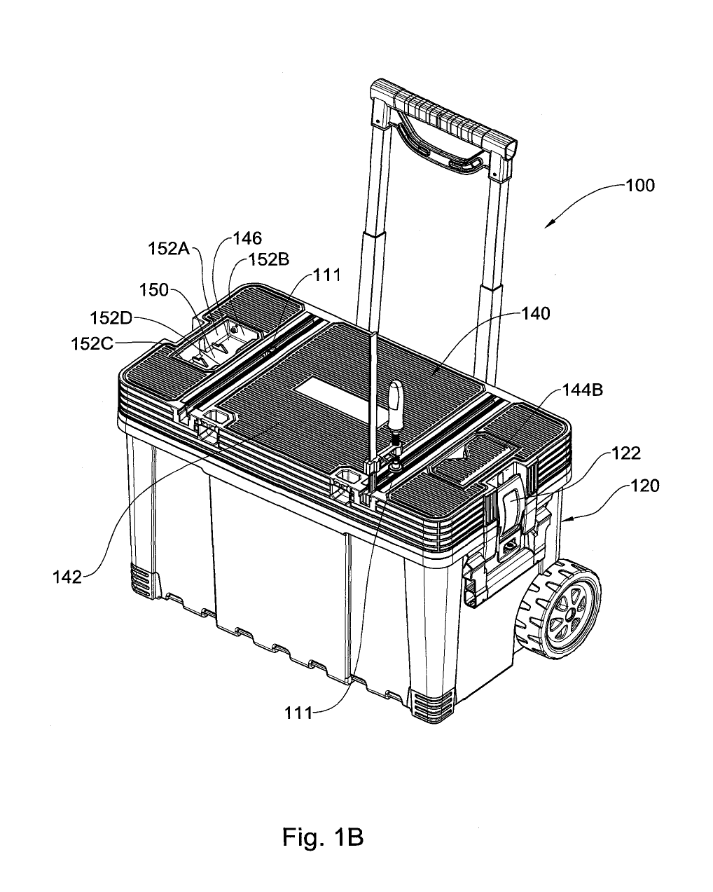

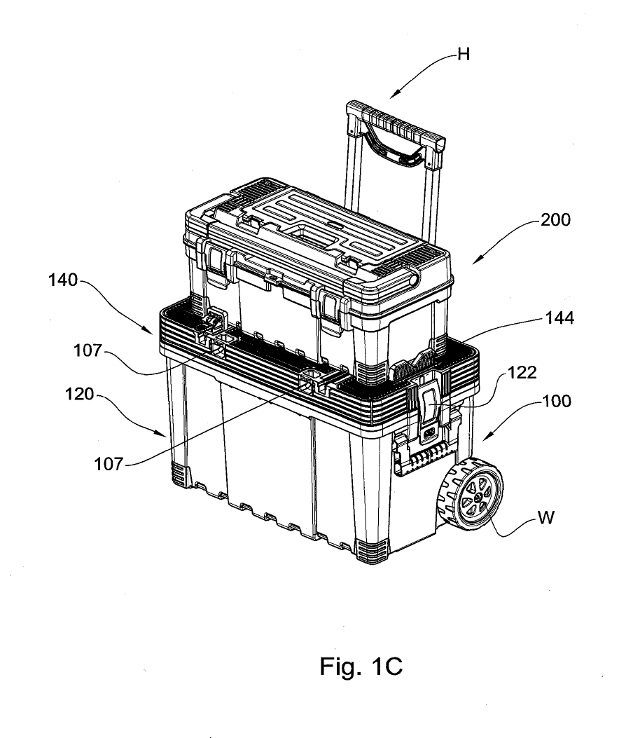

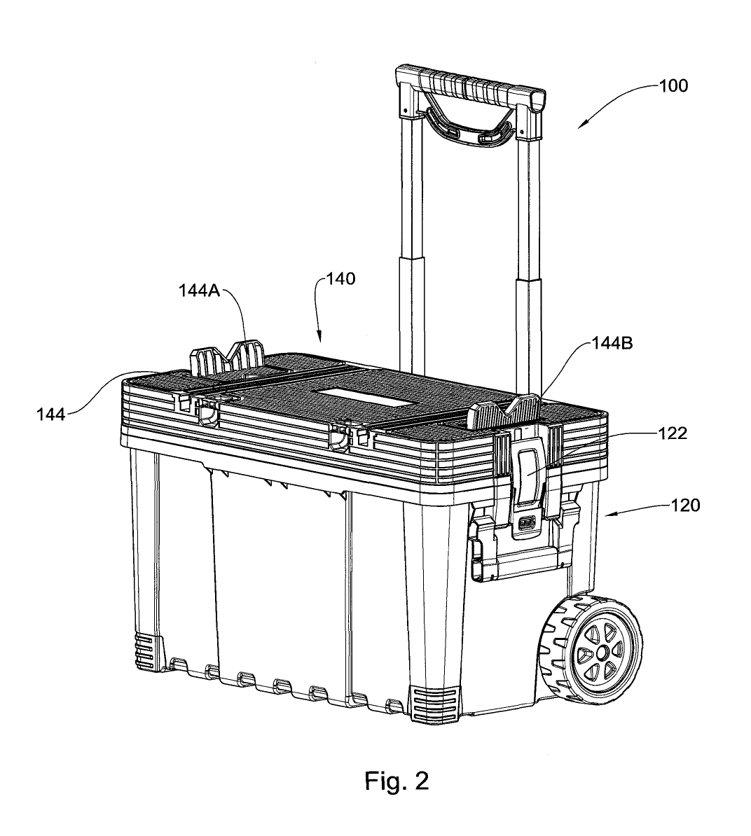

FIG. 1A illustrates the assembly 100, comprising a receptacle member 120 and a cover 140 associated therewith. The assembly, in this example, is a wheeled tool cart comprising a receptacle member 120 for tools and workpieces with the cover 140 detachably attachable thereto and secured by means of latches 122 configured at two opposite ends of the receptacle member 120 and configured for latching and consequently locking over the respective ends of the cover 140 provided with corresponding latching member (not seen). The assembly further comprises a pair of wheels 105 disposed at its rear end and an upwardly extending telescopic handle H to allow the rolling of the assembly. It will be appreciated that the cover can be a detachable member configured for mounting over the upper edges of the receptacle member 120 as seen in the illustrated example. According to another example, the cover can be configured for sliding articulation over the top edges of the receptacle member. According to yet an example, the cover can be hinged to the top edge of the receptacle member.

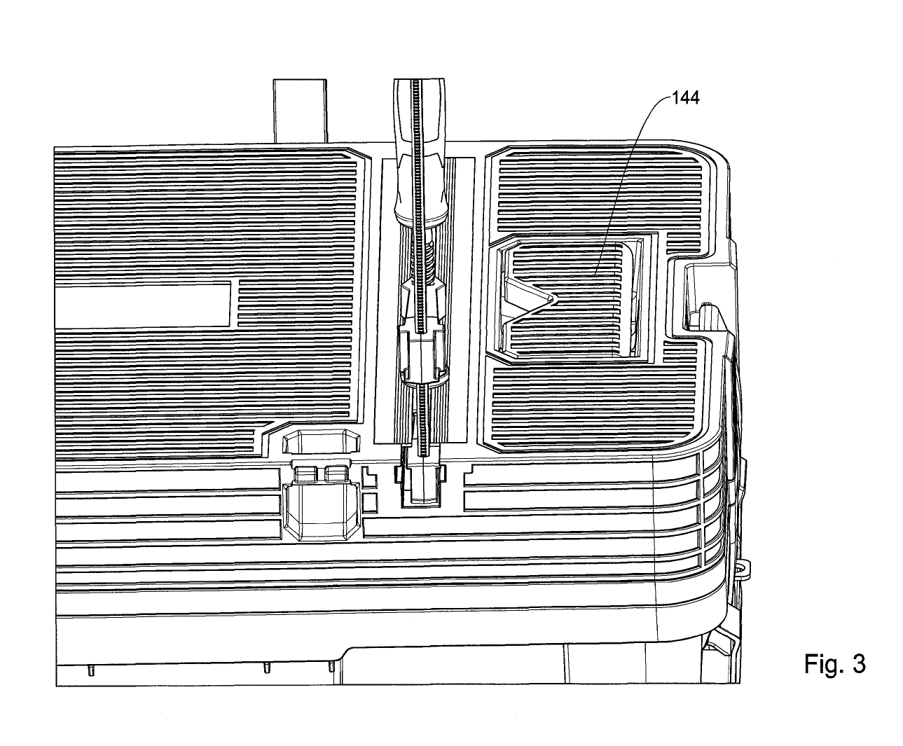

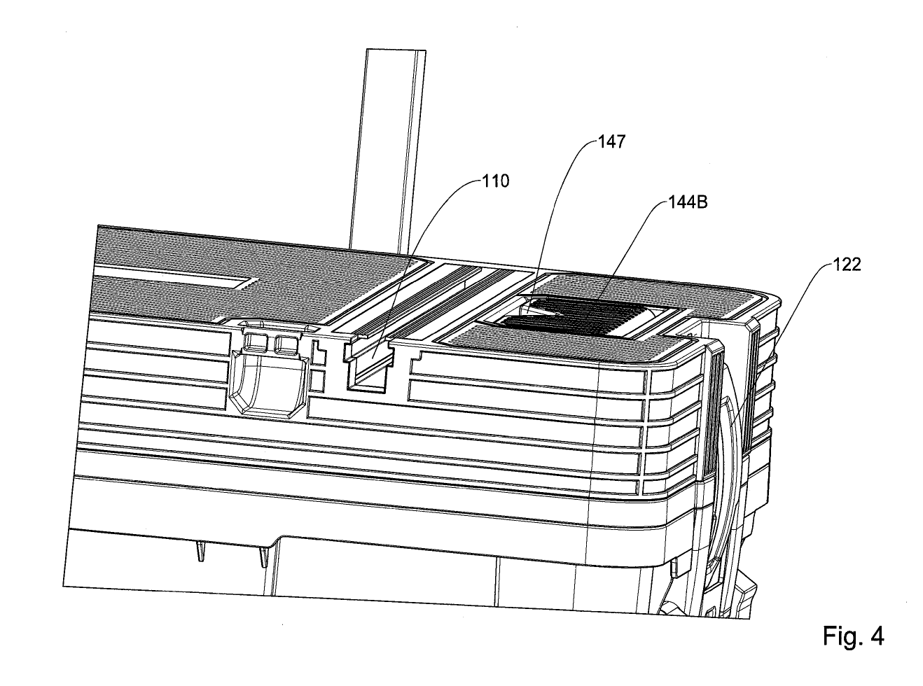

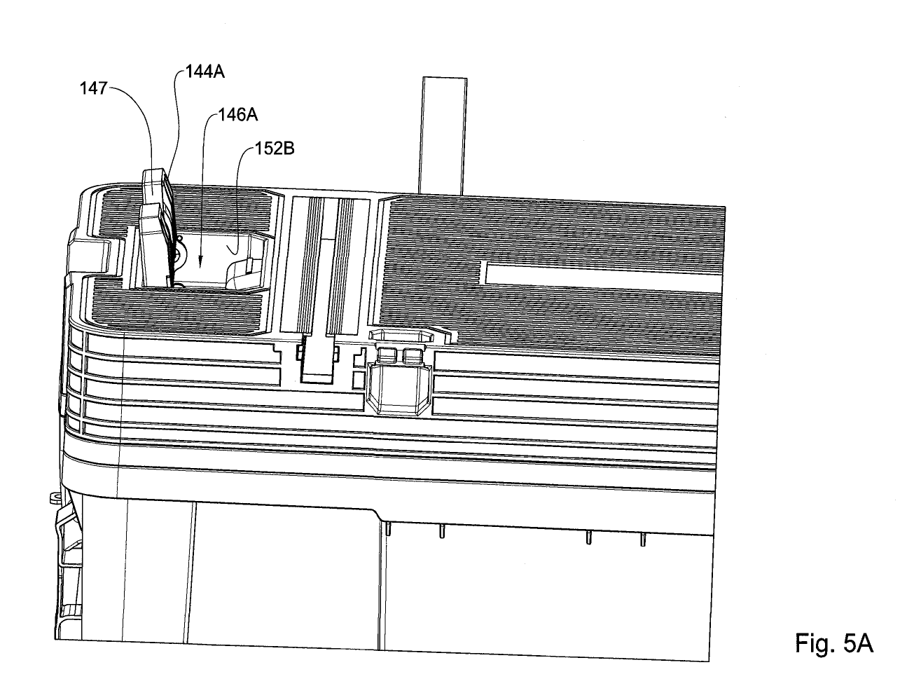

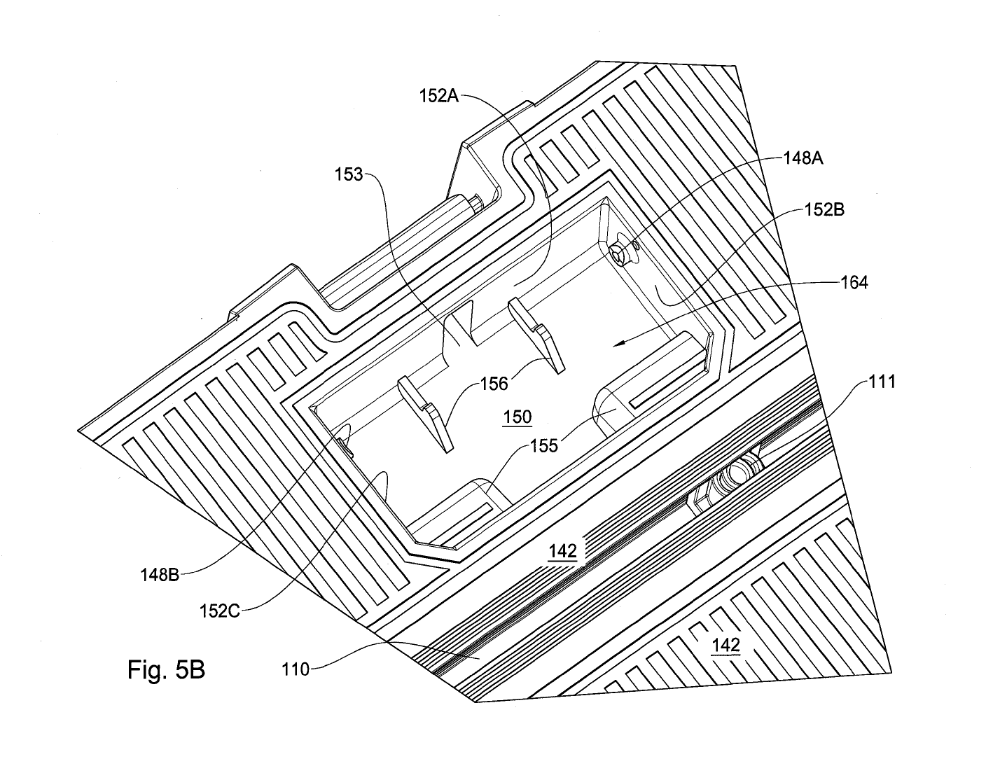

The cover 140 comprises a top surface 142 and a bottom surface B (not shown) with at least the top surface constituting a work top of the portable workbench 100. The top surface of the cover comprising two parallely extending elongate cavities extending inboard from the front edge of the cover towards an opposite edge thereof. In the illustrated example the cavities are in the form of a pair of substantially parallely disposed T-slots 110 embedded within the top face 142. The T-slots 110, are typically made of metal and are configured for slidingly receiving T-bolts (e.g. bolt 111 of FIG. 5B) which can be useful for supporting a workpiece and workpiece manipulation and restraining members such as clumps, saws, vices, etc. (as seen e.g. in FIGS. 1A, 1B, 3, 6). The T-slot 110 can also be used for slidingly articulation thereto of sliding clamps useful for example for securing a workpiece and the like.

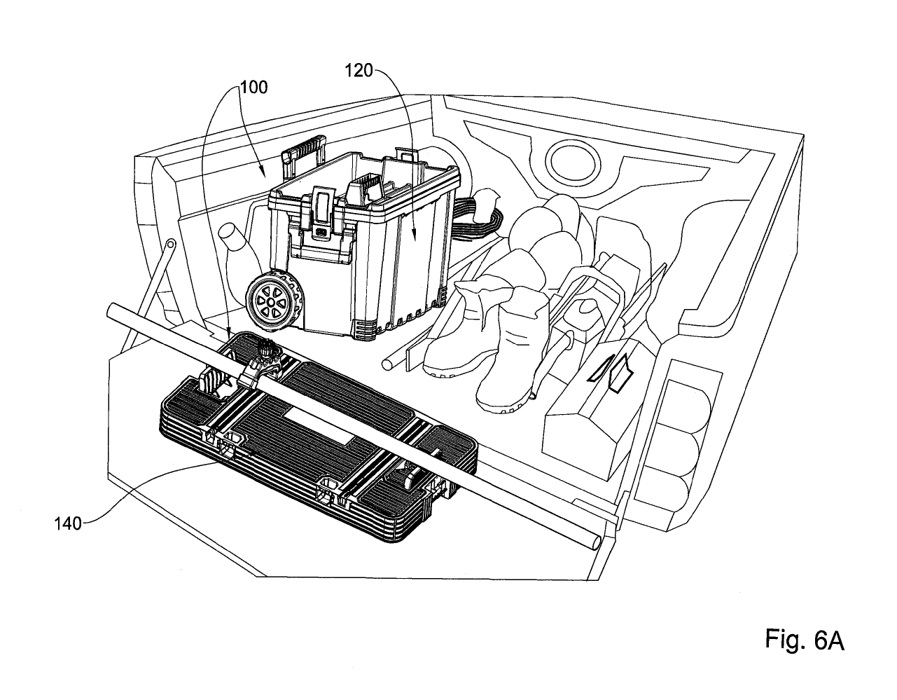

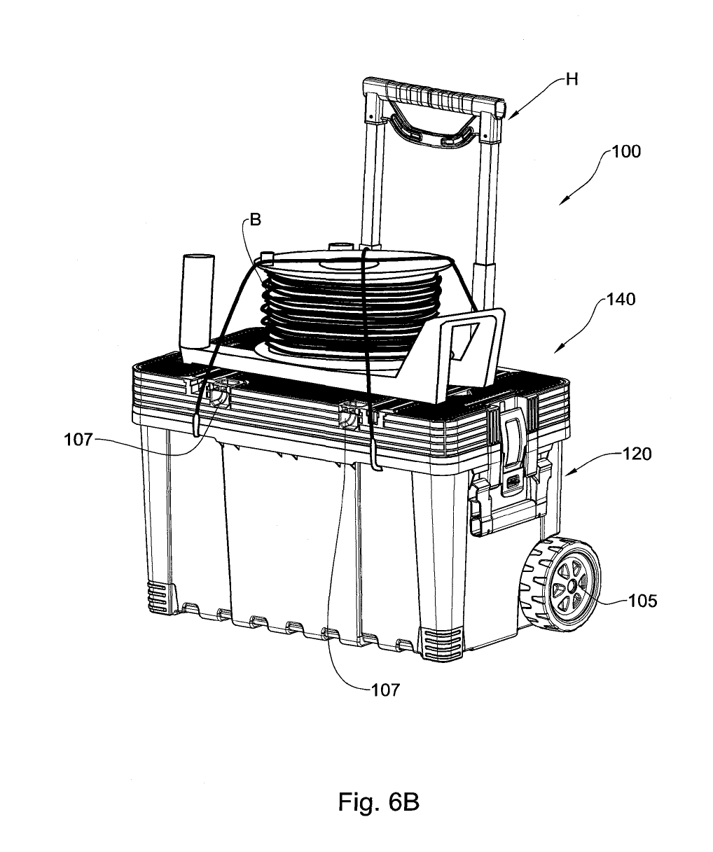

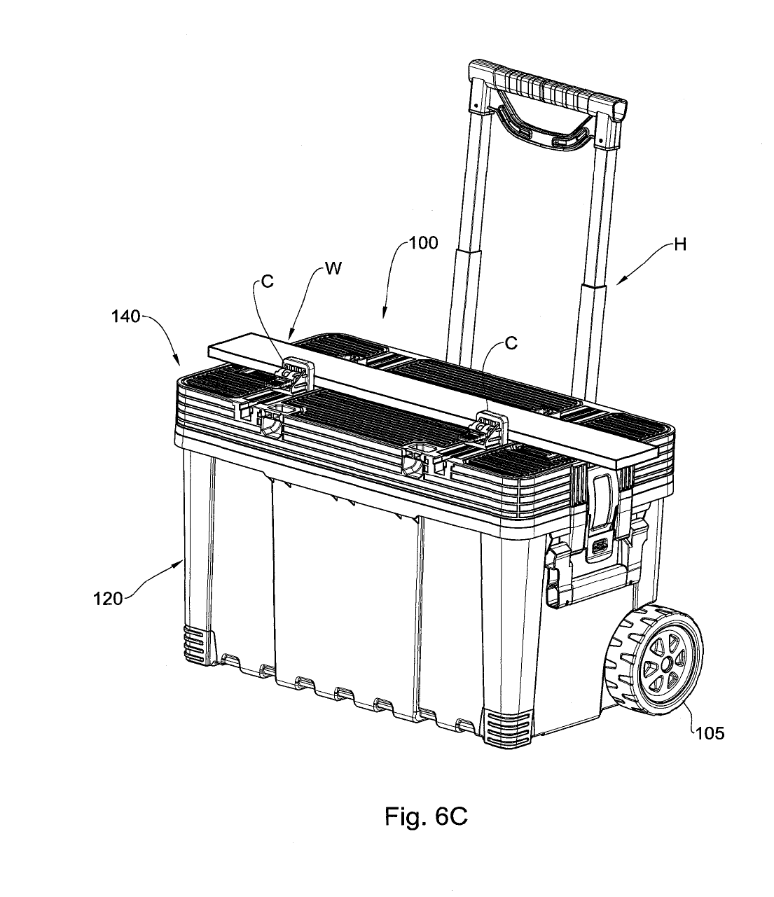

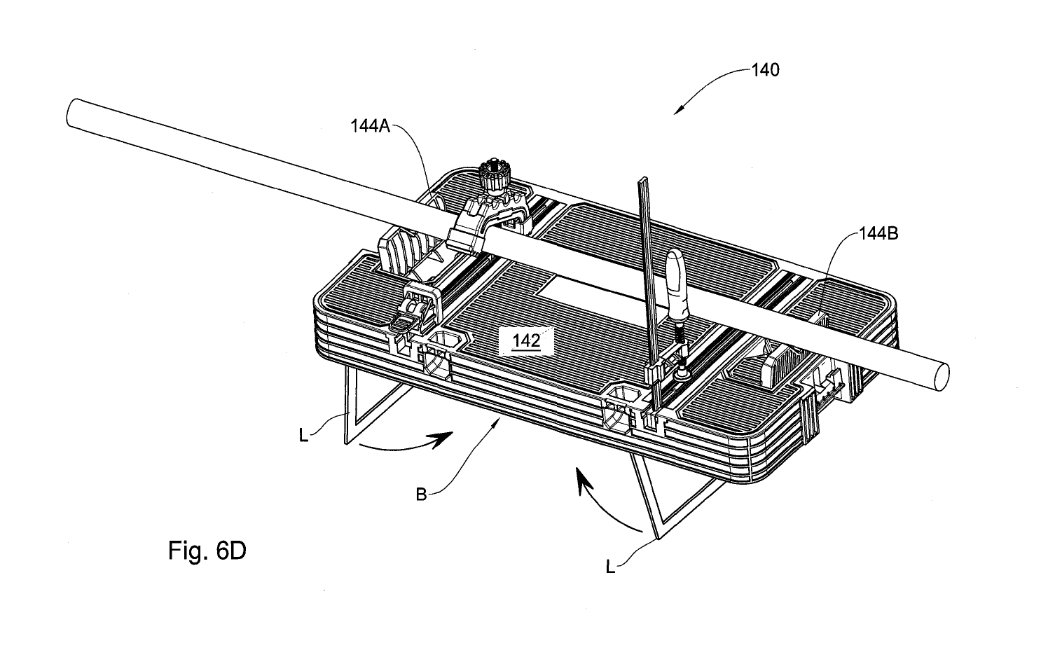

The cover 140 is further configured (typically at front/rear/side walls) with several loops 107 which can be used for articulation of personal articles while working (e.g. gloves, safety goggles, etc.), or for articulation thereto of a shoulder carrying strap (not shown) or a strap for connecting an article thereon, e.g. another toolbox or a utility article (e.g. seen in FIG. 6B).

The work top surface 142 further comprises two support flaps 144A and 144B. The top surface is provided with respective cavities 146A and 146B substantially corresponding in dimensions to the shape of the support flaps. The cavities have a bottom surface 150, and sidewalls 152A, 152B, 152C and 152D circumferentially extending upwards therefrom such that the edge of the sidewalls is flush with the top surface 142. The support flaps 144A and 144B are pivotally attached at the cavity in this example by means of two outwardly protruding elements 148A and 148B, extending at opposite edges of the cavity walls 152B and 152C and configured to be slidingly received within corresponding openings in the support flaps (not seen). To prevent unintentional disengagement and to slightly elevate the support flap for the bottom surface 150, there is provided a restriction wall 156 extending from the bottom surface 150. The restriction wall is essentially an L-shaped member extending from the bottom surface, connected at its one end to the side wall and having a free end defined by the short leg of the L-shaped member. This configuration facilitates at least a first position for the support flap in which it is folded into the cavity 146A and is substantially flush with the top surface 142 of the work top 140 and a second position in which it extends perpendicular thereto. To hold the support flap substantially flush with the top surface 142, in this example the cavity is provided with a couple of elevating elements 155 configured to hold the free end of the support flap at a position in which it is being elevated so as to be aligned with the hinged edge and flush with the top surface. It will be appreciated that while in the present example the elevating elements are provided at the cavity, and in particular extending from the bottom surface thereof, in alternative examples, the elevating elements 155 can be provided at the respective end of the support flap. Alternatively, the assembly can be devoid of such elements.

As further seen in FIG. 5, the sidewall 152A is provided with an opening 153 which facilitates ventilation and release of any fluids that might be gathered in the cavity 146, e.g. rain water, industry oils, paint, etc. As seen in the illustrated example, the support flaps 144A and 144B are provided with a cutout or a notch 147 at their top edge. This notch is provided for example to support a workpiece, e.g. a pipe as seen in FIG. 1A, to be worked on when the support flap is in its operational position, extending substantially perpendicular to, and at a height respective to, the top surface of the workbench. The notch also facilitates unfolding and withdrawal of the support flap from the cavity 146. It will be appreciated that other configurations are envisioned that can facilitate extraction of the support flap 144 and pivoting thereof relative to the top surface 142 (e.g. a strap, a depression or a bulge that will facilitate gripping thereof).

As seen in FIG. 1C, the support flaps 144A and 144B are further used to restrain a toolbox 200 that is positioned on top of the cover 140. The position of the support flaps 144A and 144B substantially define the dimensions of the toolbox that can be restrained thereby. In accordance with an example of the disclosed subject matter, the workbench surface can be configured with several spaced apart support flaps, such as to facilitate support for articles of different sizes placed on the surface of the cover 140.

FIGS. 1A to 1C and FIGS. 6A to 6D illustrate the workbench in various operational positions. While FIGS. 1A to 1C and FIGS. 6B and 6C illustrate the workbench as part of the workbench assembly, in this case a tool box cover, FIG. 6A illustrates the workbench 140 detached from the toolbox container and resting on the open back door of the pickup truck. As seen in this illustration, the workbench surface has the two support flaps 144A and 144B in an unfolded configuration, extending above the surface 142 of the cover. The support flaps support a pipe to be worked on with a pipe arresting workpiece received within the T-Slot 110, restraining the pipe in its position. To prevent unintentional movement of the cover from the surface, in this example the door, the bottom side of the cover is provided with anti skid elements at its corners (not seen).

Although not illustrated, it will be appreciated that the bottom surface of the cover can further be provided with articulation mechanisms for removably fastening to various surfaces, e.g. suction cups, rubber anti skid surfaces, etc. (not shown). In accordance with yet an example, it will be appreciated that the cover can be fitted to detachably attachable extensions configured to support it in elevation above ground surface, e.g. as a workbench, while allowing access to the container/tool box receptacle detached therefrom. Such extension can be for example in the form of two or more support legs. The support legs can be configured for sturdy and fast mounting and detaching to/from leg mounts configured at the bottom face of the cover 140. The support legs in accordance with one example are configured at their top end with a mounting arrangement for fast attaching/detaching from the leg mounts. In accordance with another example the support legs can be configured for snap attachment within the leg receptacle, e.g. at the bottom side of the cover 140, when at the stowed position. The support legs can be configured for screw-coupling to the leg mounts configured at the bottom face of the cover, alternatively the support legs can be configured for snap articulation into leg mounts configured at the bottom face of the workbench.

In accordance with yet an option, the support legs can be configured with a bayonet type articulation into leg mounts configured at the bottom face of the workbench. In accordance with yet an example as illustrated in FIG. 6D, the support legs L can be a fixed feature of the bottom side B of the workbench 140, wherein the legs L are folded up against the bottom surface B of the workbench 140 when in a stowed position and extending at an angle to the bottom surface when in an operative position, the angle being sufficient to support the cover thereupon (e.g. >90 degrees).

1. A portable workbench assembly comprising a receptacle and a cover therefore, the cover constituting a workbench, the cover having a top surface and a bottom surface with at least the top surface constituting a work top of the workbench, the top surface of the cover comprising at least one utility portion and further comprising at least one support flap, the support flap having at least a first position in which it extends flush with the top surface of the work top and second position in which it extends at an angle thereto.

2. The workbench assembly of claim 1, comprising two support flaps extending at opposite ends of the cover, wherein in the second position one edge of one or more of the two support flaps is articulated to the work top and the opposite edge extends at a height thereabove.

3. The workbench assembly of claim 1, wherein the at least one support flap is hingedly attached such that it is pivotally movable between at least the first and the second positions.

4. The workbench assembly of claim 1, wherein the at least one support flap is configured for supporting a toolbox of smaller dimensions such that its sidewalls are restrained by the at least one support flap.

5. The workbench assembly of claim 1, wherein the worktop is configured with receptacles and/or compartments and/or trays configured at the top face thereof.

6. The workbench assembly of claim 1, wherein the worktop is configured with compartments constituting drawer-like receptacles.

7. The workbench assembly of claim 1, wherein the worktop is configured with at least one carrying handle.

8. The workbench assembly of claim 1, wherein the worktop is configured with at least one movable carrying handle.

9. The workbench assembly of claim 1, wherein the worktop is configured for detachably attaching thereto utility hooks configured for supporting elongate beams.

10. The workbench assembly of claim 1, wherein the worktop is configured with modular utility portions.

11. A portable toolbox comprising a receptacle member and a cover associated therewith, the cover comprising a top surface and a bottom surface with at least the top surface constituting a work top of the portable toolbox, the top surface of the cover comprising at least one elongate cavity extending inboard from the edge of the cover and the work top further comprising at least one support flap, the support flap having at least a first position in which it extends flush with the top surface of the work top and a second position in which it extends at an angle thereto.

12. The portable toolbox of claim 11, wherein the at least one flap extends perpendicular to the top surface.

13. The portable toolbox of claim 11, comprising two support flaps extending at opposite ends of the cover surface, and wherein in the second position one edge of the support flap is articulated to the work top and the opposite edge extends at a height thereabove.

14. The portable toolbox of claim 11, wherein the support flaps are configured with a utility portion for supporting an elongate member thereon.

15. The portable toolbox of claim 11, wherein the bottom surface of the cover is further provided with articulation mechanisms for removably fastening to various surfaces.

16. The portable toolbox of claim 11, wherein the bottom surface of the cover is further provided with detachably attachable extensions configured to support it in elevation above ground surface.

17. The portable toolbox of claim 11, wherein the bottom surface of the cover is further provided with extensions configured to support it in elevation above ground surface, the extensions being in the form of two or more support legs.

18. A cover constituting a workbench, the cover having a top surface and a bottom surface with at least the top surface constituting a work top of the workbench, the top surface of the cover comprising at least one utility portion and further comprising at least one support flap, the support flap having at least a first position in which it extends flush with the top surface of the work top and second position in which it extends at an angle thereto.

19. The cover of claim 18, configured to cover a receptacle member.

20. The cover of claim 18, configured to cover a receptacle member constituting a toolbox.
